(19) United States
(12) Patent Application Publication
(10) Pub. No.: US 2019/0048838 A1
(43) Pub. Date: Feb. 14, 2019

(54) FUEL INJECTOR

(71) Applicant: SCANIA CV AB, Södertälje (SE)

(72) Inventor: Kim KYLSTRÖM, Tullinge (SE)

(73) Assignee: Scania CV AB, Södertälje (SE)

(21) Appl. No.: 15/759,716

(22) PCT Filed: Sep. 12, 2016
(86) PCT No.: PCT/SE2016/050847

§ 371 Date: Mar. 13, 2018

(30) Foreign Application Priority Data
Sep. 14, 2015 (SE) 1551167-8

(51) Int. Cl. F02M 61/18

(52) U.S. Cl. CPC F02M 61/1833; F02M 61/1846; F02M 61/184

(57) ABSTRACT

A fuel injector for a compression ignited engine comprises an injector nozzle with a nozzle body having at least one spray hole with a hole entry from a sack on the inside of the nozzle body and a hole exit on the outside of the nozzle body. The hole entry of the spray hole has a cross-section being elliptical and larger than the cross-section of the hole exit of the spray hole. The cross-sections of the hole entry and the hole exit of the spray hole are concentric as seen in the direction of a centre axis of the spray hole intersecting said cross-section.

### TECHNICAL FIELD OF THE INVENTION

The present invention relates to a fuel injector for a compression ignited engine comprising an injector nozzle with a nozzle body having at least one spray hole with a hole entry from a sack on the inside of the nozzle body and a hole exit on the outside of the nozzle body, said hole entry of the spray hole having a cross-section being elliptical and larger than the cross-section of said hole exit of the spray hole.

The invention is not restricted to such fuel injectors for injection of any particular fuel, but diesel and ethanol may be mentioned by way of examples. Furthermore, the invention relates to fuel injectors used to inject fuel into cylinders in compression ignited combustion engines designed for any type of use, such as in industrial applications, in grinding machines and all types of motor vehicles, although the invention is particularly applicable to utility vehicles, especially wheeled utility vehicles, such as trucks or lorries and buses.

Neither is the invention restricted to any types of fuel injectors, such as a separate so-called unit injector for each cylinder of an engine with a plurality of cylinders or a fuel injector in common to all cylinders of the engine. Due to large variations of pressure of the fuel injected into a cylinder while passing from said sack to said spray hole exit problems with cavitation may occur. This will result in formation of deposits in said spray hole which will result in a reduction of the maximum flow rate through the spray hole being detrimental to the performance of the engine in which the injector is installed and may also result in an increase of NON-emissions resulting from the combustion of the fuel in the cylinder.

### BACKGROUND ART

A fuel injector according to the introduction is known through for example JP 2007315279. By designing the spray hole entry with an elliptical cross-section said problems of cavitation is reduced. However, there is a desire to provide a fuel injector of this type having a further improved behaviour.

### SUMMARY OF THE INVENTION

The object of the present invention is to provide a fuel injector of the type defined in the introduction being improved in at least some aspect with respect to such fuel injectors already known.

This object is obtained by providing such a fuel injector with the feature of the characterizing part of appended patent claim 1.

The concentrically arrangement of the hole entry and the hole exit of the spray hole is favourable for the uniformity of the movement of the fuel through the spray hole and into the cylinder chamber located at the hole exit resulting in a better performance of the engine provided with the fuel injector.

According to an embodiment of the invention the fuel injector comprises a plurality of said spray holes distributed around the periphery of said sack, and said spray holes are arranged with the cross-section of the hole entry thereof having the minor-axis of the ellipse directed along the circumference of the sack towards adjacent spray holes. This orientation of the hole entry cross-section ellipse of the spray holes makes it possible to arrange the spray holes at a higher density than would the orientation of said ellipse be different. This means that for a determined number of said spray holes of the fuel injector said sack may be made smaller, which results in less emissions produced when running the engine and an increased efficiency of the engine.

According to another embodiment of the invention the minor-axis of the cross-section ellipse of the entry hole of said at least one spray hole is 0.05-0.5 mm or 0.1-0.3 mm.

According to another embodiment of the invention the cross-section of said at least one spray hole decreases continuously from the hole entry to the hole exit, which is favourable for a smooth pressure increase and a flow of fuel without occurrence of cavitation.

According to another embodiment of the invention the K-factor in the direction of the major-axis of the cross-section ellipse of the hole entry of said at least one spray hole is 2-15, 3-10 or 5-8, in which the K-factor in a direction x is defined as

$${K}_{x} = \frac{{d}_{xen} - {d}_{xex}}{L} \times 100$$

in which
dₓₑₙ=dimension of hole entry cross-section in x-direction,
dₓₑₓ=dimension of hole exit cross-section in x-direction
L=length of the spray hole, i.e. distance between hole entry and hole exit.

Such a K-factor in the direction of the major-axis of the cross-section ellipse of the hole entry of the spray hole is favourable for avoiding said cavitation problems.

According to another embodiment of the invention said hole exit has a circular cross-section.

According to another embodiment of the invention the radius of the circular cross-section of the hole exit is the same as the semi minor-axis of the elliptical cross-section of the hole entry. This results in a K-factor being zero in that direction and positive in all other directions resulting in good prospects for avoiding cavitation problems.

According to another embodiment of the invention the hole exit of said at least one spray hole has an elliptical cross-section. According to a further development of this embodiment the K-factors in the direction of the major-axis and in the direction of the minor-axis of the entry hole cross-section ellipse of said at least one spray nozzle are positive, which is favourable for the attempt to totally avoid occurrence of said cavitation.

According to another embodiment constituting a further development of the embodiment last mentioned both said K-factors are 0.5.

According to another embodiment of the invention the major-axis and the minor-axis of the hole entry cross-section ellipse are flushed with the major-axis and the minor-axis, respectively, of the hole exit cross-section ellipse of said at least one spray hole. This relative orientation of said cross-sections of the spray hole is favourable for avoiding cavitation and obtaining desired velocity gradients of the fuel travelling through the spray hole.

According to another embodiment of the invention the major axis and minor-axis of the hole exit cross-section ellipse are turned around said centre axis of said at least one spray hole with respect to the major-axis and minor-axis, respectively, of the hole entry cross-section ellipse of that spray hole. This way of turning the cross-section ellipse results in a secondary velocity vector tending to increase the mixing of air and fuel moving through the spray hole resulting in an improved performance of the engine provided with the fuel injector.

According to another embodiment of the invention said axes of the hole exit cross-section ellipse are turned by −90°-90° or −30°-30° or 30°-90° with respect to said axes of the hole entry cross-section ellipse.

The invention also relates to a compression ignited engine according to claim 14 and a motor vehicle according to claim 15.

Other advantageous features as well as advantages of the present invention appear from the description following below.

### BRIEF DESCRIPTION OF THE DRAWINGS

With reference to the appended drawings, below follows a specific description of embodiments of the invention cited as examples.

In the drawings:

FIG. 1 is a simplified cross-section view showing a schematic structure of a fuel injector of the type to which the present invention belongs,

FIG. 2 is a schematic view of a part of the fuel injector shown in FIG. 1 where the sack and the spray holes are located,

FIG. 3 is a very schematic view in the direction of the arrows III-Ill in FIG. 2 showing the sack of the fuel injector according to FIG. 1 and how spray holes are connected thereto,

FIG. 4 is a schematic view illustrating the arrangement of a spray hole in a fuel injector according to the present invention, and

FIG. 5-7 are schematic views illustrating the cross-sections of the hole entry and the hole exit of a spray hole of fuel injectors according to different embodiments of the present invention.

### DETAILED DESCRIPTION OF EMBODIMENTS OF THE INVENTION

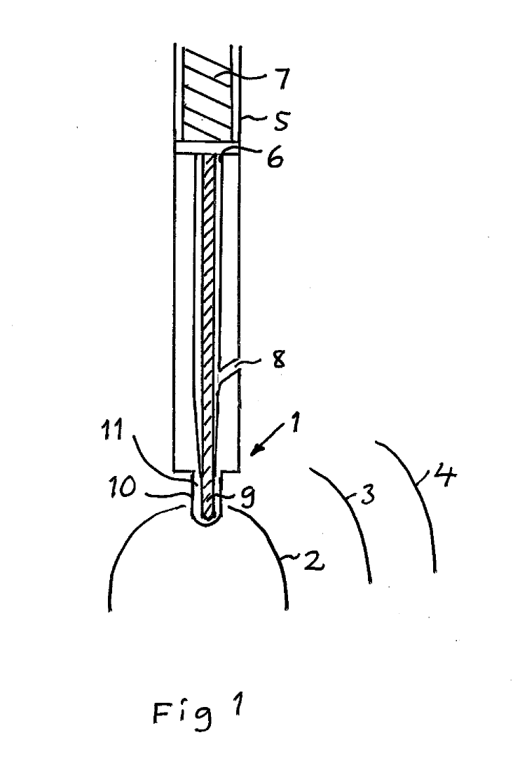

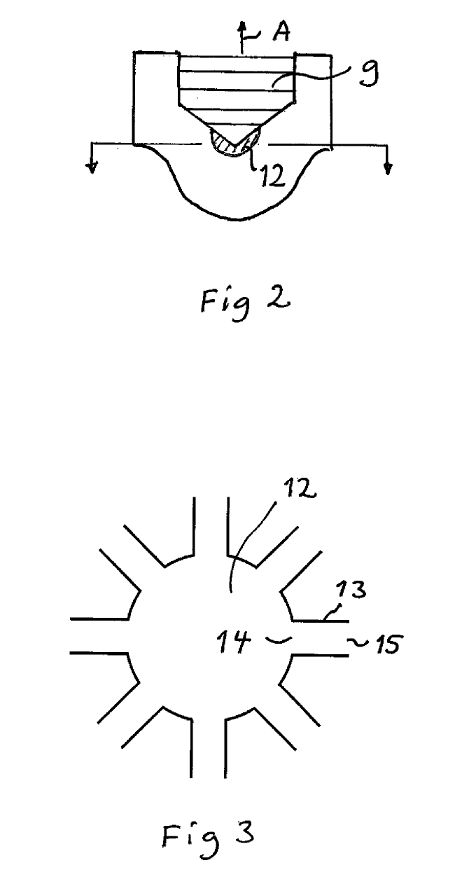

FIG. 1 illustrates schematically the general structure of a fuel injector 1 of the type to which the present invention belongs for injecting fuel into a cylinder 2 of a combustion engine 3 in a motor vehicle 4. The injector has a pump body 5 with a pumping chamber 6 and a piston 7 movably arranged therein. It is schematically shown how fuel may be introduced to the pumping chamber through a channel 8. An injector plunger 9 is movably arranged in a nozzle body 10 of an injector nozzle 11 and held, by a spring member not shown, in a state closing a connection of fuel in the pumping chamber 6 with a sack 12 (see FIG. 2) being connected to the interior of the cylinder 2 through spray holes not shown in these figures but discussed below while making reference to FIGS. 3-7. The fuel injector is configured to inject fuel into the cylinder 2 as of a fuel pressure inside the pumping chamber 6 of a predetermined level overcoming the action of the spring member and moving the injector plunger in the direction of the arrow A in FIG. 2. Thus, this fuel injector is a pump injector, but the invention is not restricted to any special type of fuel injectors but is particularly applicable to common rail injectors.

FIG. 3 illustrates schematically the sack 12 as seen in the direction opposite to the arrow A in FIG. 2 and how spray holes 13 with a hole entry 14 from the sack on the inside of the nozzle body and a hole exit 15 on the outside of the nozzle body are arranged. Adjacent spray holes 13 have to have a minimum mutual distance so that the number of spray holes dictates how large said sack has to be, whereas it is a desire to have a sack being as small as possible for a determined number of spray holes for reducing formation of emissions of the engine and increasing the efficiency thereof.

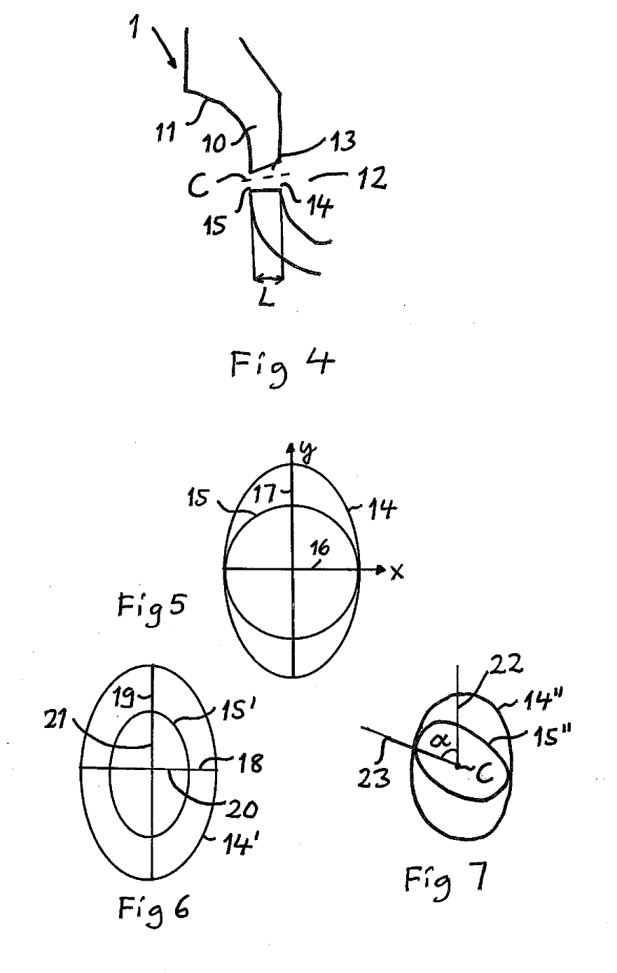

FIG. 4 illustrates schematically the arrangement of a said spray hole 13 penetrating the nozzle body 10 and extending from a hole entry 14 from the sack 12 on the inside of the nozzle body to a hole exit 15 on the outside of the nozzle body. It is seen how the hole entry of the spray hole has a cross-section being larger than the cross-section of the hole exit of the spray hole. The spray hole has a length of L. Such a spray hole may typically have a diameter of 0.05-0.5 mm and mostly of 0.1-0.3 mm. Occurrence of cavitation of fuel entering the spray hole will be counteracted by the enlarged cross-section at the entry of the spray hole.

FIG. 5 is a simplified view of a spray hole 13 seen in the direction of the extension of the spray hole of the fuel injector according to a first embodiment of the invention, in which the cross-section of the hole entry 14 has an elliptical shape with a minor-axis 16 and a major-axis 17 of the ellipse and the cross-section of the hole exit 15 has a circular shape, and these two cross-sections are concentric as seen in the direction of a centre axis C of the spray hole. A K-factor defines the degree of change of a cross-section dimension from the hole entry to the hole exit and is positive if this cross-section dimension decreases in said direction and negative if it increases. This K-factor is in the direction x shown in FIG. 5 zero and in the direction y positive and calculated as

$${K}_{y} = \frac{{d}_{yen} - {d}_{yex}}{L} \times 100$$

in which
d_{yen}=dimension of hole entry cross-section in y-direction,
d_{yer}=dimension of hole exit cross-section in y-direction
L=length of the spray hole, i.e. distance between hole entry and hole exit.

The factor K_{y} is preferably 2-15 and most preferred 5-8 in the y-direction, which results in an efficient avoiding of occurrence of cavitation of fuel passing through the spray hole. Furthermore, the concentrically arrangement of the hole entry cross-section and the hole exit cross-section is favourable for obtaining a uniform velocity gradient of the flow of fuel through the spray hole. The lifetime of the fuel nozzle of the fuel injector according to the present invention may be substantially prolonged, such as by a factor in the order of 10-50, with respect to fuel injectors already known, especially due to the lower degree of cavitation obtained through the design of the spray holes.

FIG. 6 illustrates the cross-section shapes of a hole entry 14′ and a hole exit 15′ of a spray hole in a fuel injector according to a second embodiment of the invention, in which both these cross-sections are elliptical with minor-axes 18, 20 and major-axes 19, 21 and the spray hole is tapering from the entry to the exit, which means that the K-factor will here be positive in all directions and accordingly in x-direction as well as in y-direction for efficiently avoiding occurrence of cavitation of fuel flowing through the spray hole.

FIG. 7 illustrates the cross-sections of the hole entry 14″ and the hole exit 15″ of a spray hole in a fuel injector according to a third embodiment of the invention. The hole entry cross-section is elliptical and this ellipse is continuously decreasing while turning around said centre axis C in the direction towards the whole exit, so that the major-axis 23 of the exit cross-section ellipse will be turned by an angle α with respect to the major-axis 22 of the entry hole cross-section ellipse. α is in this case about 60°. This results in a high K-factor in y-direction and also a positive K-factor in the x-direction counteracting occurrence of cavitation. This turning of the continuously decreasing cross-section also results in a secondary velocity vector of fuel travelling through the spray hole promoting mixing of air and fuel of the mixture of fuel and air sprayed through the spray hole.

The invention is of course in no way restricted to the embodiments described above, since many possibilities to modifications thereof are likely to be obvious to one skilled in the art without having to deviate from the scope of invention defined in the appended claims.

1. A fuel injector for a compression ignited engine comprising an injector nozzle with a nozzle body having at least one spray hole with a hole entry from a sack on the inside of the nozzle body and a hole exit on the outside of the nozzle body, said hole entry of the spray hole having a cross-section being elliptical and larger than the cross-section of said hole exit of the spray hole, wherein the cross-sections of the hole entry and the hole exit of the spray hole are concentric as seen in the direction of a center axis of the spray hole intersecting said cross-sections.

2. A fuel injector according to claim 1 further comprising, a plurality of said spray holes distributed around the periphery of said sack, and that said spray holes are arranged with the cross-section of the hole entry thereof having the minor-axis of the ellipse directed along the circumference of the sack towards adjacent spray holes.

3. A fuel injector according to claim 1, wherein the minor-axis of the cross-section ellipse of the entry hole of said at least one spray hole is in the range of 0.05-0.5 mm or the range of 0.1-0.3 mm.

4. A fuel injector according to claim 1, wherein the cross-section of said at least one spray hole decreases continuously from the hole entry to the hole exit.

5. A fuel injector according to claim 1, wherein a K-factor in the direction of the major-axis of the cross-section ellipse of the hole entry of said at least one spray hole is 2-15, 3-10 or 5-8,
in which the K-factor in a direction x is defined as
$${K}_{y} = \frac{{d}_{yen} - {d}_{yex}}{L} \times 100$$
d_{yen}=dimension of hole entry cross-section in y-direction,
d_{yex}=dimension of hole exit cross-section in y-direction, and
L=length of the spray hole, which is the distance between hole entry and hole exit.

6. A fuel injector according to claim 1, wherein said hole exit has a circular cross-section.

7. A fuel injector according to claim 6, wherein the radius of the circular cross-section of the hole exit is the same as the semi minor-axis of the elliptical cross-section of the hole entry.

8. A fuel injector according to claim 1, wherein the hole exit of said at least one spray hole has an elliptical cross-section.

9. A fuel injector according to claim 5, wherein the K factors in the direction of the major-axis and in the direction of the minor-axis of the hole entry cross-section ellipse of said at least one spray nozzle are positive.

10. A fuel injector according to claim 9, wherein both said K-factors are ≥0.5.

11. A fuel injector according to claim 8, wherein the major-axis and the minor-axis of the hole entry cross-section ellipse are flush with the major-axis and minor-axis, respectively, of the hole exit cross-section ellipse of said at least one spray hole.

12. A fuel injector according to claim 8, wherein the major-axis and minor-axis of the hole exit cross-section ellipse are turned around said center axis of said at least one spray hole with respect to the major-axis and minor-axis, respectively, of the hole entry cross-section ellipse of that spray hole.

13. A fuel injector according to claim 12, wherein said axes of the hole exit cross-section ellipse are turned by −90°-90° or −30°-30° or 30°-90° with respect to said axes of the hole entry cross-section ellipse.

14. A compression ignited engine comprising at least one fuel injector, wherein said fuel injector comprises: an injector nozzle with a nozzle body having at least one spray hole with a hole entry from a sack on the inside of the nozzle body and a hole exit on the outside of the nozzle body, said hole entry of the spray hole having a cross-section being elliptical and larger than the cross-section of said hole exit of the spray hole, wherein the cross-sections of the hole entry and the hole exit of the spray hole are concentric as seen in the direction of a center axis of the spray hole intersecting said cross-sections.

15. A motor vehicle comprising a compression ignited engine with at least one fuel injector, said fuel injector comprising: an injector nozzle with a nozzle body having at least one spray hole with a hole entry from a sack on the inside of the nozzle body and a hole exit on the outside of the nozzle body, said hole entry of the spray hole having a cross-section being elliptical and larger than the cross-section of said hole exit of the spray hole, wherein the cross-sections of the hole entry and the hole exit of the spray hole are concentric as seen in the direction of a center axis of the spray hole intersecting said cross-sections.
